(19) United States
(12) Patent Application Publication
(10) Pub. No.: US 2024/0362271 A1
(43) Pub. Date: Oct. 31, 2024

(54) METHODS AND APPARATUS TO MODIFY REQUESTS FOR MEDIA

(71) Applicant: DIRECTV, LLC, El Segundo, CA (US)

(72) Inventors: Reza Pezeshki, Chevy Chase, MD (US); Richard Tatem, Middletown, MD (US); Horia-Mihai Popa, Iasi (RO); Matei Dediu, Bucharest (RO); Wassim Daccache, Ellicott City, MD (US)

(21) Appl. No.: 18/309,653

(22) Filed: Apr. 28, 2023

(51) Int. Cl. G06F 16/71

(52) U.S. Cl. CPC G06F 16/71; H04L 65/612; H04L 65/70

(57) ABSTRACT

Systems, apparatus, articles of manufacture, and methods are disclosed. An example system includes programmable circuitry; a memory that stores executable instructions that, when executed or instantiated by the programmable circuitry, facilitate performance of operations, comprising: forming a data structure representing a request to a content provider for a media stream; modifying the data structure to represent a request to a local manager for the media stream, the modified request data structure including an address corresponding to the local manager; transmitting a request to the local manager as a hypertext transfer protocol (HTTP) request, the request based on the modified data structure; and receiving a response from the local manager as a user datagram protocol (UDP) stream.

### FIELD OF THE DISCLOSURE

This disclosure relates generally to multicasting media and, more particularly, to methods and apparatus to redirect requests for media.

### BACKGROUND

In recent years, the number of devices within a given location that support media playback has increased. Conventionally, delivery of media content to multiple devices utilized a unicast architecture in which a content delivery network supports n different transmissions of the same media from a content provider to n different devices. In unicast systems, separate copies of the media content are delivered to each of the n different devices as a HTTP stream.

### BRIEF DESCRIPTION OF THE DRAWINGS

FIG. 1 is an illustrative example of a content delivery network.

FIG. 2 is a block diagram of an example implementation of the multicast environment of FIG. 1.

FIG. 3 is a block diagram of an example implementation of the local manager of FIG. 2.

FIG. 4 is a block diagram of an example implementation of the client device of FIG. 2.

FIG. 5 is an illustrative example of the client device of FIG. 2 obtaining media for playback.

FIG. 6 is a flowchart representative of example machine readable instructions and/or example operations that may be executed, instantiated, and/or performed by example programmable circuitry to implement the client device 204A or smart device 208 of FIG. 2.

FIG. 7 is a block diagram of an example processing platform including programmable circuitry structured to execute, instantiate, and/or perform the example machine readable instructions and/or perform the example operations of FIG. 6 to implement the client device 204A or smart device 208 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIG. 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily imply that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share the same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific integrated circuitry (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, Network Processing Units (NPUs) one or more microcontrollers that may execute first instructions to perform one or more operations and/or functions and/or integrated circuits such as Application Specific Integrated Circuits (ASICs). Additionally, the programmable circuitry may be implemented as an XPU that may be a heterogeneous computing system including multiple types of the above programmable circuitry (e.g., one or more FPGAs, one or more CPUs, one or more GPUs, one or more NPUs, one or more DSPs, etc., and/or any combination(s) thereof). The XPU may include orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

In some use cases, unicast systems struggle to support efficient delivery of over the top (OTT) media. As used herein, OTT media refers to media that is transmitted and/or received over the Internet. For example, consider an environment that includes both: (1) a large number of devices requesting media, and (2) legacy communications infrastructure having relatively limited total network traffic bandwidth. Such environments may include, but are not limited to, hotels, malls, restaurants, sports bars, other commercial spaces, multiple dwelling units (MDUs), residential dwellings, etc. If such environments utilize a unicast content delivery network, a sufficiently large number of devices (n) requesting media at the same time can result in the need to transmit data that exceeds (or constitutes a disproportionate amount of) the total network traffic bandwidth available in the environment. As a result, one or more media playback sessions in the environment may experience a decrease in quality due to buffering, disconnections, etc. Additionally or alternatively, the large request for data from the n devices requesting media may cause other devices (e.g., phones, tablets, laptops) attempting to use the environment's local network to experience disconnections or other latencies. In some examples, a device requesting media is referred to as a client device.

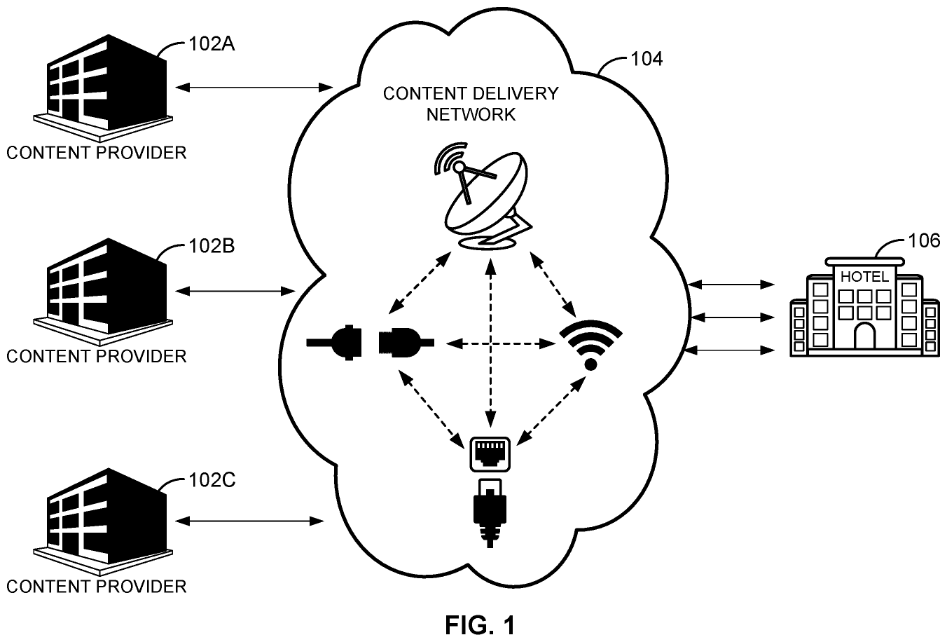

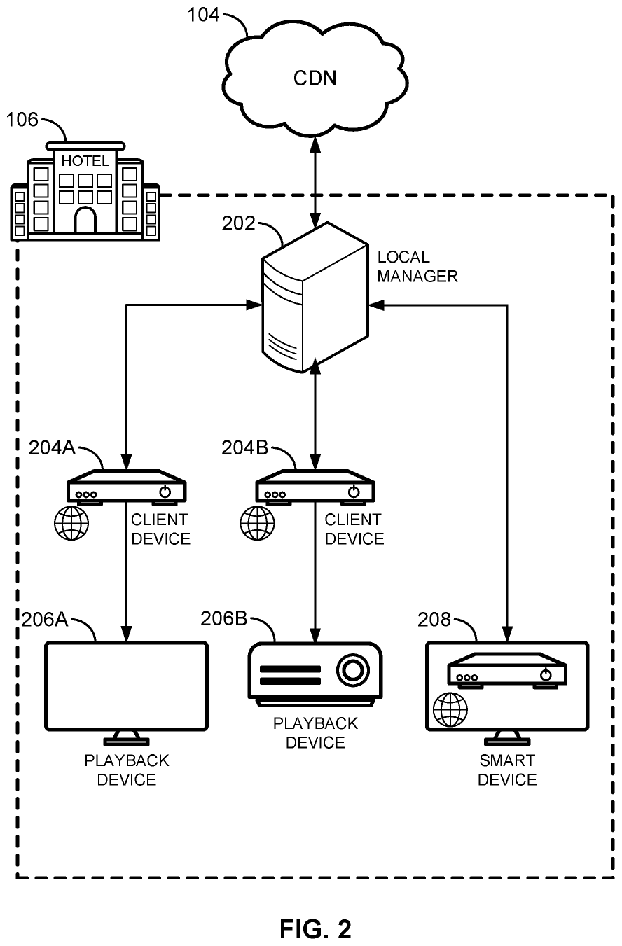

Multicast content delivery systems may be utilized to decrease total network traffic and improve user experiences. In a multicast architecture, a content delivery network enables one transmission of a media stream from a content provider to a primary device (e.g., a server) located within the environment. The primary device then transmits n copies of the media stream to the n devices within the environment requesting the same media at approximately the same time. Using multicast, the number of transmissions (e.g., channels of communication dedicated to a particular media stream) between the environment and the content delivery network is reduced from n to 1, thereby decreasing the total network traffic and improving user experiences. As used above and herein, a media stream refers to data used to enable playback of a piece of media (e.g., a movie, a television show, a television channel, a live stream, etc.). Multicast content delivery networks are discussed further in connection with FIGS. 1 and 2.

In some previous approaches, a device forms a request for a media stream corresponding to the channel and transmits the request to a local domain name system (DNS) server. The local DNS server resolves the request by identifying an internet protocol (IP) address of a device responsible for providing the media stream (e.g., a content provider). The local DNS then sends a request for the media stream to the content provider using the identified IP address.

The use of local DNS servers is a security risk because the local DNS server may be susceptible to attacks from malicious actors. Example attacks on DNS servers include but are not limited to denial-of-service (DOS), distributed denial-of-service (DDoS), DNS hijacking, DNS spoofing, DNS tunneling, DNS amplification, DNS typosquating, etc. Furthermore, in environments that include a large number of devices requesting media and legacy networking infrastructure, the implementation of local DNS servers to obtain media may not be practicable due to cost, limited bandwidth, etc.

Another previous approach to obtain OTT media streams is HTTP redirection. In HTTP redirection, a device forms a first request for a media stream corresponding to the channel and transmits the first request to an intermediate device. The intermediate device responds to the requesting device with the address of the content provider device capable of providing the media stream. The requesting device then forms a second request for the media stream and transmits the second request directly to the content provider.

The foregoing re-direction of the media request introduces latency and decreases the quality of the user experience. The latency occurs because, before initializing media playback, the requesting device must transmit a first request to the intermediate device, waits for the intermediate device to respond, transmit a second request to the content provider, and wait for the content provider to respond.

Example methods, systems, and apparatus described herein implement a device that requests OTT media by leveraging a multicast content delivery network. A client device includes beacon agent circuitry that receives a beacon message from a local manager and extracts a local manager IP address from the beacon message. The client device also includes request modifier circuitry that receives a request for media directed to a first device (e.g., a local DNS server or an intermediate device as described above). The request modifier circuitry modifies the request so that the client device transmits the request to the local manager rather than the first device. The local manager communicates over the content delivery network to obtain the requested media stream and provide the stream to the client device. Advantageously, the client device receives the requested media without knowing the address of the content provider, without receiving a re-direct, and without the security risks of local DNS servers. As a result, the client device described herein exhibits decreased latency and better user quality than devices utilizing previous approached to request OTT media.

FIG. 1 is an illustrative example of a content delivery network. FIG. 1 includes content providers 102A, 102B, 102C, a content delivery network (CDN) 104, and a multicast environment 106.

The content providers 102A, 102B, 102C each correspond to a different media stream. The media stream may be formatted as a linear television channel, a live stream, a video on demand (VOD) or streaming platforms, etc. The media stream may correspond to any type of content, including news, sports, television shows, movies, etc. FIG. 1 illustrates three content providers 102A, 102B, 102C for simplicity. In practice, a given device may request media from any number of content providers.

A given content provider 102A may host one or more compute devices (e.g., servers) that receive requests for content and provide a corresponding media stream via the CDN 104. In some examples, the content provider 102A provides OTT media as HTTP with TCP because the usage of the CDN 104, which includes third party devices not associated with either of the content provider 102A or multicast environment 106, prevents transmission with less secure protocols such as UDP.

In FIG. 1, the CDN 104 enables communication between each of the content providers 102A, 102B, 102C and the multicast environment 106. More generally, the CDN 104 exchanges data between content providers and devices requesting media from the content providers. The data exchange may include HTTP requests and HTTP streams as described above.

The CDN 104 may be implemented by any number of internal nodes using any number of transmission mediums and any number of communication topologies. In the illustrative example of FIG. 1, the CDN 104 is the Internet. However, the CDN 104 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The multicast environment 106 refers to any environment with a plurality of devices requesting related media. In examples described herein, the multicast environment 106 is a hotel. In other examples, the multicast environment 106 is a sports bar, a mall, a household with multiple televisions, other commercial or residential dwellings, etc. The multicast environment 106 implements a multicast system in accordance with the teachings of this disclosure. As part of the multicast system, the multicast environment 106 communicates via the CDN 104 with each of the content providers 102A, 102B, 102C to request content and receive the corresponding media streams. The multicast environment 106 is discussed further in connection with FIG. 2.

FIG. 2 is a block diagram of an example implementation of the multicast environment of FIG. 1. FIG. 2 includes the CDN 104 and the multicast environment 106. The multicast environment 106 includes a local manager 202, client devices 204A and 204B, collectively referred to as client devices 204, playback devices 206A and 206B, collectively referred to as playback devices 206, and a smart device 208.

The local manager 202 is a device that multicasts media streams within the multicast environment 106 in accordance with the teachings of this disclosure. In the illustrative example of FIG. 2, the local manager 202 receives three requests for media streams from the client devices 204. The three requests each correspond to the same media stream (e.g., media from content provider 102A). Upon receiving the requests, the local manager 202 sends a single request for the media stream to the content provider 102A via the CDN 104 and receives a single HTTP media stream. The local manager 202 then provides a UDP stream to each of the client device 204A, client device 204B, and smart device 208.

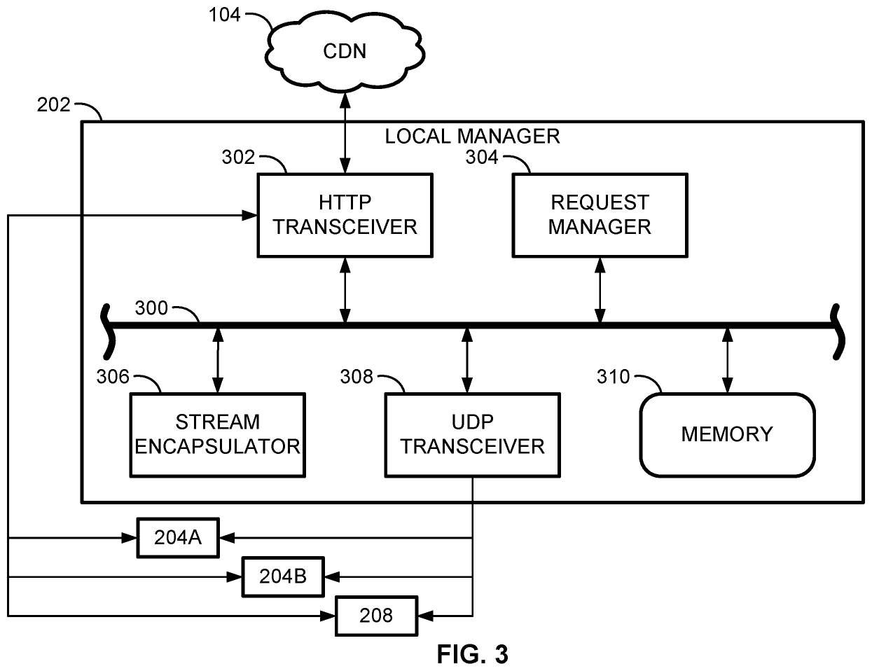

In general, the local manager 202 makes one request and receives one media stream over the CDN 104 per unique request generated from the client devices within the multicast environment 106. For example, suppose each of n client devices request media from one of y different media streams (meaning that y≤ n, as a client device may only present one media stream at a time). In such examples, the local manager 202 makes y different transmissions over the CDN 104. The y transmissions are more efficient than a unicast architecture (in which each of the client devices communicates separately over the CDN 104, causing n different transmissions). Accordingly, the multicast system for content delivery reduces network traffic when compared to unicast systems. The local manager 202 is discussed further in connection with FIG. 3.

The client devices 204 are devices that request media in accordance with the teachings of this disclosure. The client devices 204 form requests for media based on user input. The client devices 204 may use any suitable form of user input, including but not limited to button presses from a remote or software application, voice commands, etc. In some examples, one or more of the client devices 204 generate requests for both linear television channels and VoD/streaming content. In such examples, the client devices 204 include Internet connections to request media streams, receive media metadata, receive user interface data, receive media streams, etc.

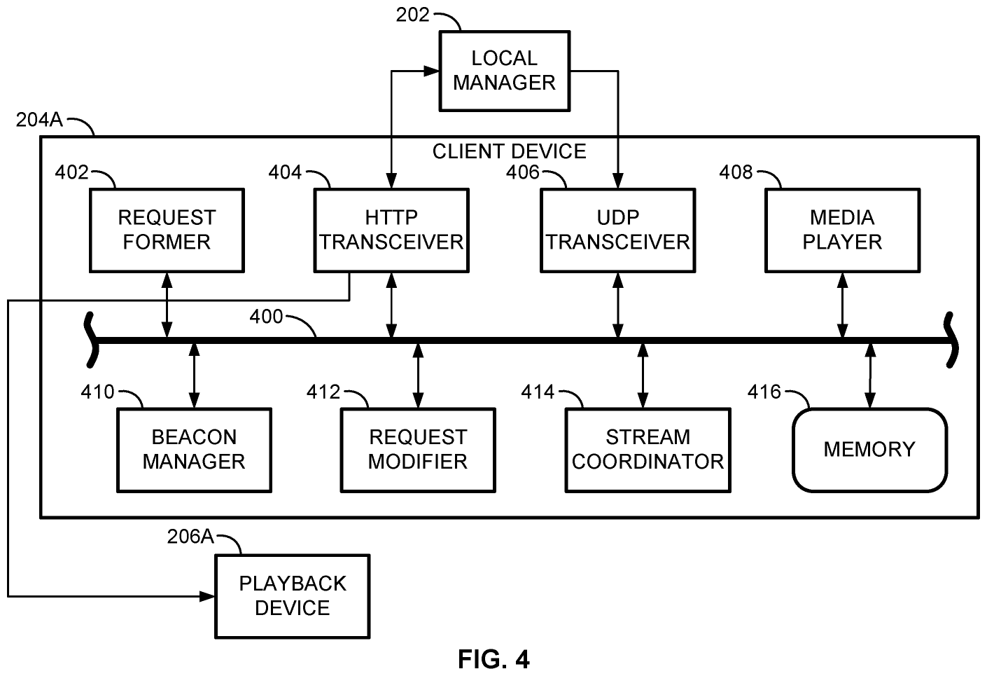

In the illustrative example of FIG. 2, each of the client devices 204 requests the same media stream. The client devices 204 transmit the request to the local manager 202, receive the corresponding media stream, and provide the resulting media data (e.g., synchronized image and audio data) to their respective playback devices 206. The client devices 204 may communicate with the local manager 202 using any suitable LAN topologies that support both HTTP and UDP transmissions. In some examples, a client device is referred to as a set top box (STB). In other examples, client devices may take other forms such as software applications operations on smart televisions, etc. The client devices 204 are discussed further in connection with FIG. 4.

The playback devices 206A, 206B receive the media data from the client devices 204A, 204B respectively. The playback devices 206 present the media data so it is viewable by a user. The playback devices 206 may be implemented by any device that can present media and communicate with the client devices 204. For example, in FIG. 2, the playback device 206A is a television and the playback device 206B is a projector. The playback devices 206 receive media data from the client devices 204 using any suitable communication interface. Example communication interfaces for video transmission include but are not limited to Universal Serial Bus-C(USB-C), High Definition Multimedia Interface (HDMI), Digital Visual Interface (DVI), DisplayPort, Video Graphics Array (VGA), Radio Corporation of America (RCA) cables, etc. In some examples, the playback devices 206 have internal speaker components to present the audio portion of the media. In other examples, the playback devices 206 connect to external speakers to present the audio.

The smart device 208 is a device that includes the functionality of both the client devices 204 and playback devices 206. That is, the smart device 208 forms requests for media based on user input, transmits requests for media to the local manager 202, receives a multicast media stream from the local manager 202, and presents the media on a display. In some examples, the smart device 208 includes an Internet connection to implement a web application. The smart device 208 is discussed further in connection with FIG. 4.

While FIG. 2 shows two client devices 204A, 204B and one smart device 208 for simplicity, any number of client devices 204 or smart devices 208 may be implemented within the multicast environment 106. For example, a hotel may include either a client device 204A or a smart device 208 in each hotel room so that the device used by guests to view media (e.g., either a playback device 206 or a smart device 208) receives said media as part of the multicast system. Generally, the multicast environment 106 implements one client device (e.g., client device 204A) for each playback device (e.g., playback device 206A).

FIG. 2 describes two client devices 204 and a smart device 208 that are each requesting the same media stream. The local manager 202 receives the three requests, determines if each request identifies the same media stream, and transmits only requests that reaches the CDN 104. In doing so, the local manager 202 implements media multicasting and reduces the network traffic between the hotel and the CDN 104.

While multicasting techniques generally decrease network traffic between a local network (e.g., the multicast environment 106) and an external network (e.g., the CDN 104), other media multicast environments exhibit a large volume of traffic within the local network. Such other environments include client devices configured to send all media requests to local DNS servers or intermediate devices, which increase latency within the local network and decrease the quality of the user experience as described above.

Advantageously, the client devices 204 and the smart device 208 requests media directly from the local manager 202 in accordance with the teachings of this disclosure. As a result, the multicast environment 106 exhibits fewer communications between devices within the local network than client devices that request media from a DNS server or intermediate device.

By avoiding re-directs, the client devices 204 and the smart device 208 are able to receive video data corresponding to a specific media stream faster than other devices that transmit a request for the specific media stream to an intermediate device. The decrease in the amount of internal network traffic dedicated to media transfer also means the local network has more available bandwidth for internal communications. The extra bandwidth may be used to improve the performance of other functions not related to media transfer.

Furthermore, the avoidance of re-directs enables the client devices 204 and the smart device 208 to communicate with the local manager 202 and determine which media streams are available within the multicast environment 106 faster than other client devices that do utilize re-directs. In some examples, the process in which a client device 204A or the smart device 208 obtains information that a media stream is accessible by the local manager 202 (and therefore is available for presentation on the playback device 206A) is referred to as a discovery process.

FIG. 3 is a block diagram of an example implementation of the local manager 202 of FIG. 2 to multicast media. The local manager 202 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the local manager 202 of FIG. 2 may be instantiated by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. FIG. 3 includes the CDN 104, local manager 202, the client devices 204, and the smart device 208. The local manager 202 includes a bus 300, HTTP transceiver circuitry 302, request coordinator circuitry 304, stream encapsulator circuitry 306, UDP transceiver circuitry 308, and memory 310.

The bus 300 refers to one or more physical connection (e.g., an interconnect, copper trace, etc.) that enables communication between the UDP transceiver circuitry 308, HTTP transceiver circuitry 302, stream encapsulator circuitry 306, request coordinator circuitry 304, and memory 310. The bus 300 may be implemented using one or more communication systems that meet pre-determined threshold power and latency requirements.

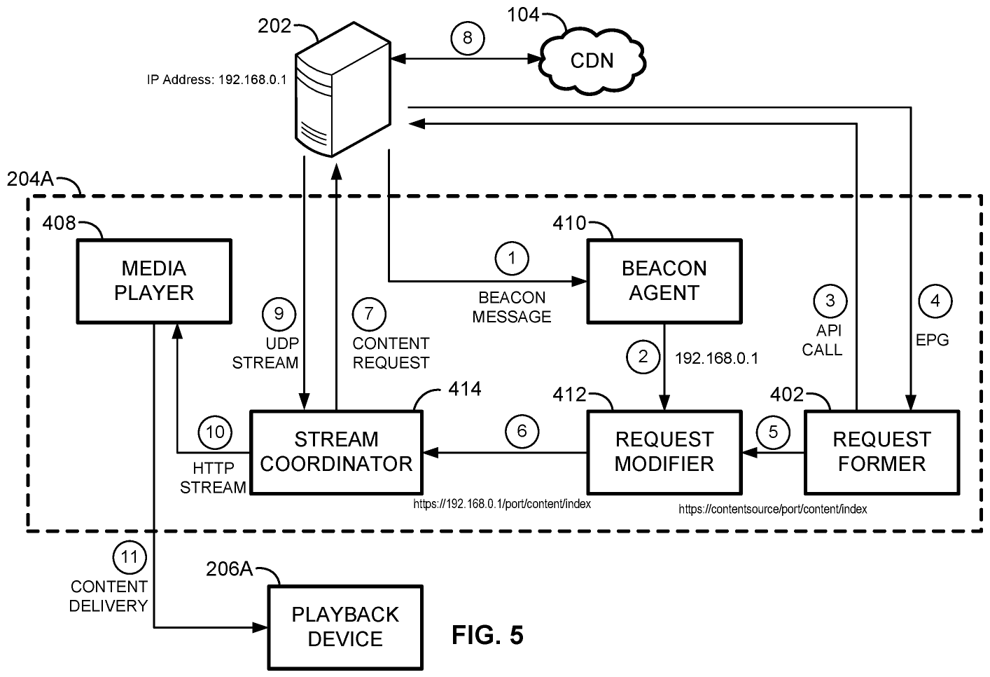

The HTTP transceiver circuitry 302 transmits and receives data with HTTP. For example, the HTTP transceiver circuitry 302 receives HTTP requests from the client devices 204. The HTTP transceiver circuitry 302 also transmits HTTP requests to the CDN 104 and receives HTTP streams from the CDN 104. The HTTP transceiver circuitry 302 receives an instruction to transmit data from another internal component of the local manager 202 via the bus 300. Similarly, after receiving data from an external device, the HTTP transceiver circuitry 302 provides the data to another internal component of the local manager 202 via the bus 300. In some examples, the HTTP transceiver circuitry 302 is instantiated by programmable circuitry executing HTTP transceiver instructions and/or configured to perform operations such as those discussed in connection with FIG. 5.

The request coordinator circuitry 304 receives HTTP and organizes requests for media streams. The HTTP requests are generated by the client devices 204 and are provided to the request coordinator circuitry 304 by the HTTP transceiver circuitry 302 via the bus 300. When the request coordinator circuitry 304 receives two or more HTTP requests from two client devices within a threshold amount of time, the request coordinator circuitry 304 determines if the requests correspond to the same media stream. The request coordinator circuitry 304 causes the HTTP transceiver circuitry 302 to transmit a single request, via the CDN 104, for each unique media stream identified within the two or more HTTP requests.

The request coordinator circuitry 304 also ensures the local manager 202 receives requests for media from all the client devices 204 in the multicast environment 106. To do so, the request coordinator circuitry 304 repeatedly causes the UDP transceiver circuitry 308 to broadcast a beacon message to one or more devices within the multicast environment. The beacon message refers to an amount of data that describe how the request coordinator circuitry 304 is to receive all requests for media within the multicast environment 106. The beacon message may include one or more data structures, including but not limited to: the IP address of the local manager 202, a port number used to make API calls across the local network of the multicast environment 106, flags, counters, timestamps, etc. In some examples, the request coordinator circuitry 304 is instantiated by programmable circuitry executing request manager instructions and/or configured to perform operations such as those discussed in connection with FIG. 5.

After transmitting a request for media via the CDN 104, the HTTP transceiver circuitry 302 receives an HTTP stream from a corresponding content provider (e.g., content provider 102A). As used above and herein, a HTTP stream refers to data that enables playback of media using HTTP. Example HTTP streams include but are not limited to HTTP Live Steaming (HLS), Dynamic Adaptive Streaming over HTTP (DASH), and Common Media Application Format (CMAF). In some examples, a HTTP stream enables the playback of live content.

The stream encapsulator circuitry 306 receives the HTTP stream from the content provider 102A via the HTTP transceiver circuitry 302 and the bus 300. The stream encapsulator circuitry 306 segments the HTTP stream into one or more packets of data and encapsulates each HTTP packet with a UDP header. Each encapsulated packet may be referred to as a datagram. As used herein, a UDP stream refers to data that enables the communication of media utilizing UDP. A UDP stream includes one or more datagrams and metadata that describes the order of the datagrams. In some examples, the stream encapsulator circuitry 306 is instantiated by programmable circuitry executing stream encapsulator instructions and/or configured to perform operations such as those discussed in connection with FIG. 5.

The UDP transceiver circuitry 308 transmits data with the UDP. For example, the UDP transceiver circuitry 308 broadcasts beacon messages to the client devices 204 and the smart device 208 as described above. The UDP transceiver circuitry 308 also receives a UDP stream from the stream encapsulator circuitry 306 via the bus 300. The UDP transceiver transmits a copy of the UDP stream to one or more client devices 204 and/or smart device 208 as instructed by the request coordinator circuitry 304. In some examples, the UDP transceiver circuitry 308 is instantiated by programmable circuitry executing UDP transceiver instructions and/or configured to perform operations such as those discussed in connection with FIG. 5.

One or both of the HTTP transceiver circuitry 302 and the UDP transceiver circuitry 308 may include any number of hardware components to support communication with external devices. The hardware components may include but are not limited to one or more cable ports for wired communications, one or more antennas for wireless communication, etc.

The memory 310 stores data used by the other internal components of the local manager 202 to multicasting. For example, the memory 310 may include one or more caches used by the stream encapsulator circuitry 306 to encapsulate a HTTP stream into a UDP stream and by the UDP transceiver circuitry 308 to form multiple copies of the UDP stream. The memory 310 may additionally store data including but not limited to a list of content providers 102, a list of media streams, a list of client devices 204, an IP address of the local manager 202, etc.

The memory 310 may be implemented as any type of memory. For example, the memory 310 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

In general, HTTP streams are communication protocols that build upon and/or incorporate the transmission control protocol (TCP). To begin communicating using TCP, two devices must engage in a handshake process and an authentication process to identify and verify one another. While the handshake and authentication processes helps ensure accuracy and reliability, they also add latency to the data transfer process. If the local manager 202 were to transmit HTTP streams to the client devices 204, the handshake and authentication processes may cause interruptions in the time sensitive process of media transfer. The interrupts may cause buffers or disconnections in the presentation of the media and decrease the quality of the user experience. Accordingly, the local manager 202 includes the stream encapsulator circuitry 306 so a media stream can be quickly and efficiently transmitted to multiple client devices 204 as a UDP stream.

FIG. 4 is a block diagram of an example implementation of the client device 204A of FIG. 1 to request media. The client device 204A of FIG. 2 may be instantiated (e.g., creating an instance of, bring into being for any length of time, materialize, implement, etc.) by programmable circuitry such as a Central Processor Unit (CPU) executing first instructions. Additionally or alternatively, the client device 204A of FIG. 2 may be instantiated by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. FIG. 4 includes the local manager 202, the client device 204A, and the playback device 206. The client device 204A includes a bus 400, request former circuitry 402, HTTP transceiver circuitry 404, UDP transceiver circuitry 406, media player circuitry 408, beacon agent circuitry 410, request modifier circuitry 412, stream coordinator circuitry 414, and memory 416.

In the example of FIG. 4, the bus 400, request former circuitry 402, HTTP transceiver circuitry 404, UDP transceiver circuitry 406, media player circuitry 408, beacon agent circuitry 410, request modifier circuitry 412, stream coordinator circuitry 414, and memory 416 implement the client device 204A. In some examples, the bus 400, request former circuitry 402, HTTP transceiver circuitry 404, UDP transceiver circuitry 406, media player circuitry 408, beacon agent circuitry 410, request modifier circuitry 412, stream coordinator circuitry 414, and memory 416 may additionally or alternatively implement the client device 204B and/or the smart device 208.

The bus 400 refers to one or more physical connections (e.g., an interconnect, copper trace, etc.) that enables communication between the internal components of the client device 204A. The bus 400 may be implemented using one or more communication systems that meet pre-determined threshold power and latency requirements.

The request former circuitry 402 forms request data structures that request a portion of a media stream. The request data structures generated by the request former circuitry 402 correspond to a content provider. To do so, the request former circuitry 402 may include any number of hardware components to receive inputs from a user. For example, the request former circuitry 402 may include infrared and/or Bluetooth antennas to detect keypresses from a remote control. In some examples, the request former circuitry 402 includes a microphone and a natural language processing module to receive a voice command from a user.

The request former circuitry 402 may interpret the control signal from the user (button presses, text corresponding to a voice command, etc.) to determine a particular media stream should be presented on the playback device 206A. In some examples, the request former circuitry 402 communicates with the media player circuitry 408 via the bus 400 to interpret the signal based on a user interface (UI) presented on the playback device 206A.

Before receiving or interpreting a control signal, the request former circuitry 402 may form Application Programming Interface (API) calls that are transmitted to the local manager 202 via HTTP. The API calls request Electronic Programming Guide (EPG) data. EPG data may be used by the client devices 204 or smart device 208 to both form a request for a media stream and cause presentation of said media stream. EPG data includes, but is not limited to, a list of all the available channels, metadata for each of the listed channels (logos, program poster art, descriptions, synopsis, etc.), an IP address of the local manager, and a port number for each channel. EPG data is discussed further in connection with FIG. 5.

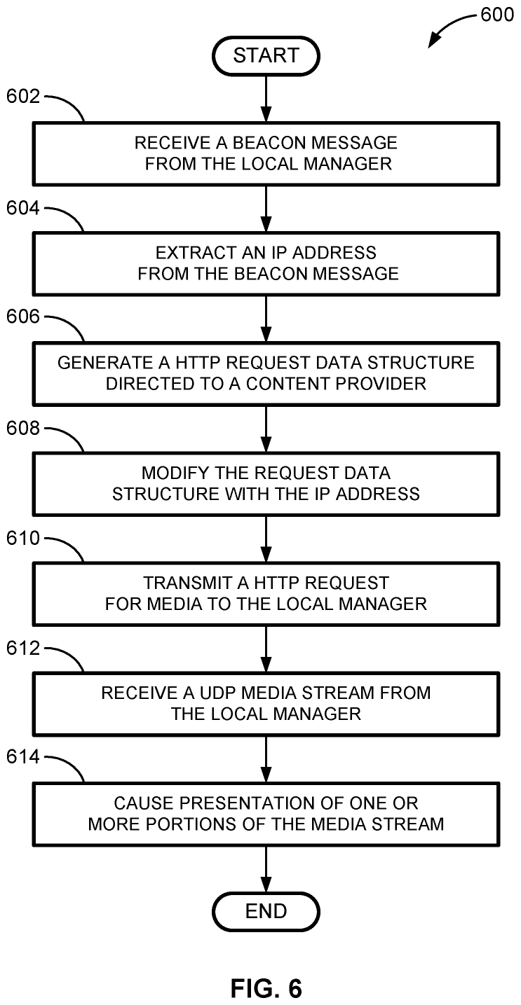

After determining that a media stream should be presented on the playback device 206A, the request former circuitry 402 produces a request data structure. A request data structure refers to any data that may be transmitted to request a media stream. Initially, the request data structure may be directed towards a content provider. In some examples, the request former circuitry 402 is instantiated by programmable circuitry executing request former instructions and/or configured to perform operations such as those represented by the flowchart(s) of FIG. 6.

The HTTP transceiver circuitry 404 transmits and receives data with HTTP. For example, the HTTP transceiver circuitry 302 transmits a HTTP request for a media stream to the local manager 202. The HTTP transceiver circuitry 302 also transmits a HTTP stream to the playback device 206A to enable presentation of the media stream. In some examples, the HTTP transceiver circuitry 404 is instantiated by programmable circuitry executing HTTP transceiver instructions and/or configured to perform operations such as those represented by the flowchart(s) of FIG. 6.

The UDP transceiver circuitry 406 transmits and receives data with UDP. For example, the UDP transceiver circuitry 406 receives a copy of a UDP stream that has been multicasted from the local manager 202. In some examples, the UDP transceiver circuitry 406 is instantiated by programmable circuitry executing UDP transceiver instructions and/or configured to perform operations such as those represented by the flowchart(s) of FIG. 6.

The media player circuitry 408 manages the image and audio data transmitted to the screen. For example, the media player circuitry 408 may implement one or more user interfaces used to present a channel guide, content search results, media controls (play, pause, forward, rewind, fast forward), etc., on the playback device 206A. The media player circuitry 408 also receives an HTTP stream and determines when to provide various portions of video data to the playback device 206A for presentation. To determine what image and video data should be presented on the playback device 206A, the media player may also interpret control signals (button presses, voice commands, etc.) generated by a user and received with corresponding hardware. In some examples, the media player circuitry 408 is instantiated by programmable circuitry executing media player instructions and/or configured to perform operations such as those represented by the flowchart(s) of FIG. 6.

The beacon agent circuitry 410 receives beacon messages transmitted by the local manager 202 via the UDP transceiver circuitry 406 and the bus 400. The beacon agent circuitry 410 performs operations and/or transmits instructions based on the contents of the beacon message. For example, the beacon agent circuitry 410 extracts the local manager IP address from the beacon message and stores the address in the memory 416. In some examples, the beacon agent circuitry 410 is instantiated by programmable circuitry executing beacon agent instructions and/or configured to perform operations such as those represented by the flowchart(s) of FIG. 6.

The request modifier circuitry 412 monitors the bus 400 for request data structures generated by the request former circuitry 402. After identifying request data structure, the request modifier circuitry 412 intercepts and modifies the request data structure. In particular, the request modifier circuitry 412 removes the identification of the content provider 102A and adds the local manager IP address from memory 416. The request modifier circuitry 412 then provides the modified request data structure to the stream coordinator circuitry 414. In some examples, the request modifier circuitry 412 is instantiated by programmable circuitry executing request modifier instructions and/or configured to perform operations such as those represented by the flowchart(s) of FIG. 6.

The stream coordinator circuitry 414 forms and interprets media stream communications with external devices. For example, the stream coordinator circuitry 414 causes the HTTP transceiver to transmit the modified request data structure to the local manager 202. The stream coordinator circuitry 414 also receives a response (i.e., a UDP stream) from the local manager via the UDP transceiver circuitry 406 and decapsulates the UDP stream to recover the internal HTTP stream. To recover the HTTP stream, the stream coordinator circuitry 414 places one or more datagrams in a specific order given by UDP stream metadata and removes the UDP headers from the datagrams. In some examples, the stream coordinator circuitry 414 is instantiated by programmable circuitry executing stream coordinator instructions and/or configured to perform operations such as those represented by the flowchart(s) of FIG. 6.

The memory 416 stores data to facilitate the operations of the internal components of client device 204. For example, the memory 416 may store a look up table used by the media player to map wireless signals to button presses, a list of local manager IP addresses identified by the beacon agent circuitry 410, etc. In some examples, the memory 416 includes a buffer to temporarily store portions of an HTTP stream before the media player circuitry 408 transmits one or more of the portions to the playback device 206A for presentation.

The memory 416 may be implemented as any type of memory. For example, the memory 416 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

In some examples, the request former circuitry 402 is implemented by standardized modules that are designed to interpret control signals and form corresponding requests for media. In such examples, the request former circuitry 402 may be configured to identify a content provider as the recipient of the request data structure by default. Similarly, the stream coordinator circuitry 414 may be implemented by a standard module that forms API calls directed to any device that is listed as the recipient of the request data structure. If the stream coordinator circuitry 414 receives a request data structure with a recipient (e.g., a content provider) having an IP address that is unknown to the client device 204A, the stream coordinator circuitry 414 may be configured to transmit the request data structure to a DNS server to resolve the request and receive the IP address. Accordingly, the use of such standardized modules in other devices can cause re-routes that increase latency in the local network and decrease the quality of user experiences as discussed above.

Advantageously, the client devices 204 are implemented with the beacon agent circuitry 410 and the request modifier circuitry 412 in accordance with the teachings of this disclosure. The beacon agent circuitry 410 and request modifier circuitry 412 enable the client device to obtain the IP address of the local manager 202 and modify the HTTP address with said IP address before the stream coordinator circuitry 414 is notified. Accordingly, when the stream coordinator circuitry 414 does receive an HTTP stream, it identifies a device with a known location (the local manager 202) rather than a device with an unknown location (e.g., a server of the content provider 102A). As a result, the stream coordinator circuitry 414 can form an API call that is transmitted directly to the local manager 202 and avoid re-directs from an intermediate device.

FIG. 5 is an illustrative example of the client device 204A of FIG. 2 obtaining media for playback. FIG. 5 includes the CDN 104, the local manager 202, and the client device 204A. FIG. 5 also includes a first signal, a second signal, a third signal, a fourth signal, a fifth signal, a sixth signal, a seventh signal, an eighth signal, a ninth signal, a tenth signal, and an eleventh signal. The signals are ordered chronologically such that, in the example of FIG. 5, transmission of the zeroth signal occurs before transmission of the first signal, transmission of the first signal occurs before the transmission of the second signal, etc. While the memory 416, HTTP transceiver circuitry 404, and UDP transceiver circuitry 406 are not illustrated in FIG. 5 for simplicity, one or more of the foregoing components of the client device 204A may be used to implement the transmission and/or reception of a signal shown in FIG. 5.

The illustrative example of FIG. 5 begins with the first signal, which the local manager 202 broadcasts to all each device requesting media in the multicast environment 106, including the client device 204A. The first signal is a beacon message that enables the client devices 204 and smart device 208 to communicate with the local manager 202 and receive multicasted media streams. The beacon message also includes a number of data structures including an IP address of the local manager 202. In the example of FIG. 5, the IP address of the local manager 202 is represented as 192.168.0.1.

The local manager 202 may repeatedly transmit, using UDP, the first signal to provide updates (e.g., access to a new media stream has been gained, access to an old media stream has been lost, etc.) and to connect with any client devices 204 that may be newly added to the local network. In some examples, the transmission of the first signal is referred to as a broadcast because the first signal is sent to multiple devices within the multicast environment 106.

The beacon agent circuitry 410 receives and interprets the beacon message from the local manager 202. For example, the beacon agent circuitry 410 extracts the IP address from the beacon message. In the second signal, the beacon agent circuitry 410 provides the IP address to the request modifier circuitry 412. In some examples, the beacon agent circuitry 410 additionally stores other data from the beacon message in the memory 416.

In the third signal, the request former circuitry 402 causes the HTTP transceiver circuitry 404 to transmit an API call to the program manager. The third signal is a request for EPG data needed to form media stream requests. The request former circuitry may use information from the beacon message to form the third signal. In some examples, the request former circuitry 402 uses the IP address of the local manager 202 and the API exposed port number to form the third signal.

In the fourth signal, the request former circuitry 402 receives, via the HTTP transceiver circuitry 404, the EPG data from the local manager 202. The EPG data includes, among other data, a list of media streams and corresponding port numbers as described above.

The request former circuitry 402 transmits the fifth signal, a request data structure, to the request modifier circuitry 412. The request former circuitry 402 may transmit the fifth signal after interpreting control signals and/or a UI to determine a user has changed a channel in a linear television environment, selected a title from a streaming video on demand (SVOD) provider, etc. The request former circuitry 402 uses EPG data from the fourth signal to form the fifth signal. For example, the EPG data identifies which port number should be used to request a particular media stream. The request data structure generated by the request former circuitry 402 is directed to a content provider. In the example of FIG. 5, the fifth signal is represented by https://contentsource.com/port/content/index. In other examples, the request data structure may include other textual data and/or numeric data.

In some examples, the request former circuitry 402 generates multiple instances of the fifth signal (i.e., multiple request data structures) that each corresponds to a different portion of the same media stream. The portions of the media stream may be defined by any unit, including but not limited to a number of video frames, beginning and end time stamps, etc. For example, the request former circuitry 402 may generate a first request data structure that corresponds to an initial set of video frames, wait a period of time, and then generate a second request data structure that corresponds to a subsequent set of video frames for the same media stream.

In some examples, each request data structure generated by the request former circuitry 402 is a separate instance of the fifth signal that triggers the generation and transmission of all subsequent signals. Accordingly, the nth instance of the fifth signal is transmitted before the nth instance of the sixth signal is transmitted, but the (n+1)th instance of the fifth signal may be transmitted either before or after the nth instance of the sixth signal is transmitted.

In FIG. 5, the request modifier circuitry 412 receives the local manager IP address before receiving the request data structure. In other examples, the request modifier circuitry 412 receives the request data structure before receiving the local manager IP address. In all examples, however, the request modifier circuitry 412 uses both the local manager IP address and the request data structure to form the sixth signal.

The request modifier circuitry 412 transmits the sixth signal, a modified request data structure, to the stream coordinator circuitry 414. To form the fourth signal, the request modifier circuitry 412 edits the request data structure to remove reference to the content provider and to insert the local manager IP address. In the example of FIG. 5, the modified request data structure is represented by https://192.168.0.1/port/content/index. In other examples, the modified request data structure may include other textual data and/or numeric data.

The stream coordinator circuitry 414 transmits, via the HTTP transceiver circuitry 404, the seventh signal to the local manager 202. The seventh signal is a HTTP request for the media stream that is interpretable by the local manager 202. To generate the seventh signal, the stream coordinator circuitry 414 uses the modified request data structure to identify the local manager 202 as the recipient of the request. The stream coordinator circuitry 414 may additionally repackage and/or reformat the modified request data structure so the corresponding HTTP request is interpretable by the local manager 202.

The local manager 202 sends and receives the eighth signals with a content provider via the CDN 104. The eighth signals refer to the transmission of a request for a media stream and the receiving of corresponding media stream.

The local manager 202 transmits the ninth signal to the stream coordinator circuitry 414. The ninth signal is a UDP media stream of the requested media. To form the sixth signal, the local manager 202 receives an HTTP stream from a content provider 102A and encapsulates the HTTP stream into a UDP stream as described above. In some examples, another client device 204B requests the same media stream within a threshold amount of time from the transmission of the fifth signal by the client device 204A. In such examples, the local manager 202 transmits two copies of the sixth signal, each containing the UDP stream, to the client devices 204A, 204B.

The stream coordinator circuitry 414 transmits the tenth signal, an HTTP stream of the requested media, to the media player circuitry 408. To form the tenth signal, the stream coordinator circuitry 414 receives the UDP stream (i.e., the ninth signal) and decapsulates the UDP stream to recover a HTTP stream. By reverting the UDP stream back to a HTTP stream, the stream coordinator circuitry 414 helps ensure the transmission of video data between the client device 204A and the playback device 206A is reliable and accurate.

The media player circuitry 408 transmits the eleventh signal to the playback device 206A. The eleventh signal includes video data corresponding to a portion of the HTTP stream. The media player circuitry 408 may determine which portions of the HTTP stream to transmit to the playback device 206A and when to transmit the portions for any reason. The determination may be based on factors that include but are not limited to which video frame is currently presented on the playback device 206A, which UI is currently presented on the playback device 206A, a control signal generated by a user, the amount of cache available on the playback device 206A, etc.

The request modifier circuitry 412 enables the client device 204A to only communicates with the local manager 202. For example, in FIG. 5, the first signal, the third signal, the fourth signal, the seventh signal, and the ninth signal are all communications between the local manager 202 and the client device 204A. Limiting communication of the client device 204A to one other device avoids re-directs, reduces network traffic, and increases the speed at which the client device 204A can discover and tune to media streams.

While an example manner of implementing the client devices 204 and smart device 208 of FIG. 2 is illustrated in FIG. 4, one or more of the elements, processes, and/or devices illustrated in FIG. 4 may be combined, divided, re-arranged, omitted, eliminated, and/or implemented in any other way. Further, the bus 400, the request former circuitry 402, the HTTP transceiver circuitry 404, the UDP transceiver circuitry 406, the media player circuitry 408, the beacon agent circuitry 410, the request modifier circuitry 412, the stream coordinator circuitry 414, and the memory 416, and/or, more generally, the client devices 204 and/or the smart device 208 of FIG. 4, may be implemented by hardware alone or by hardware in combination with software and/or firmware. Thus, for example, any of the bus 400, the request former circuitry 402, the HTTP transceiver circuitry 404, the UDP transceiver circuitry 406, the media player circuitry 408, the beacon agent circuitry 410, the request modifier circuitry 412, the stream coordinator circuitry 414, and the memory 416, and/or, more generally, the client devices 204 and/or the smart device 208, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the client devices 204 and/or the smart device 208 of FIG. 4 may include one or more elements, processes, and/or devices in addition to, or instead of, those illustrated in FIG. 4, and/or may include more than one of any or all of the illustrated elements, processes and devices.

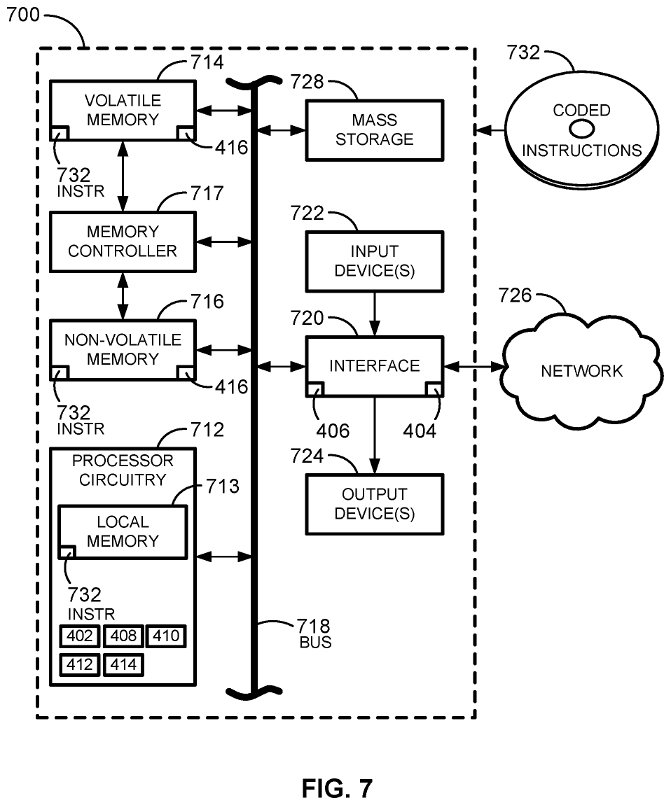

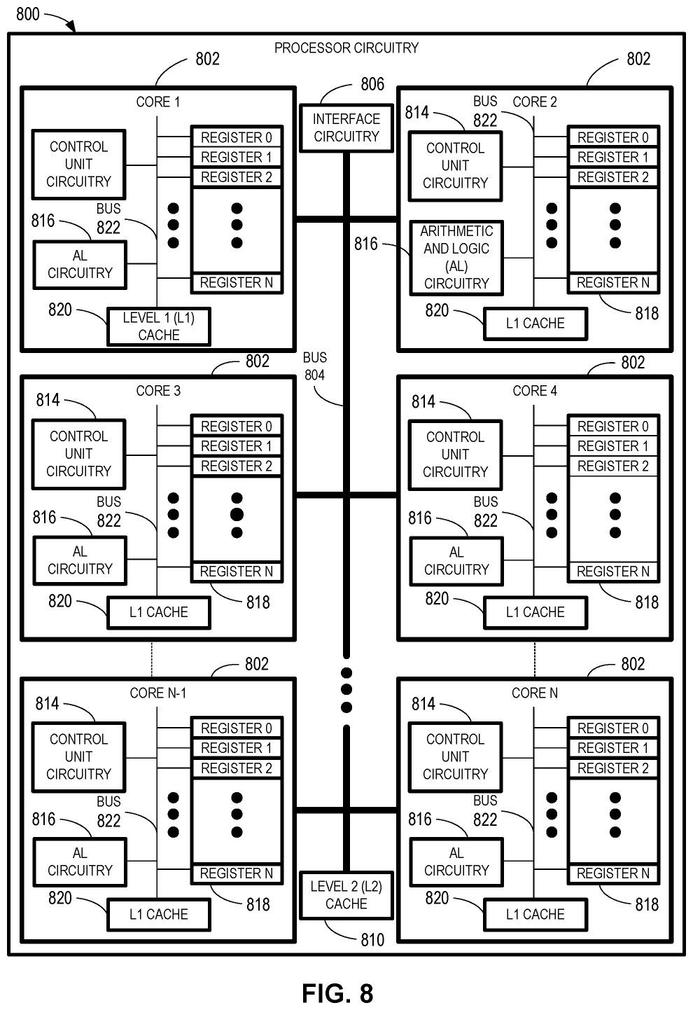

A flowchart representative of example machine readable instructions, which may be executed by programmable circuitry to implement and/or instantiate the client devices 204 and/or the smart device 208 of FIG. 4 and/or representative of example operations which may be performed by programmable circuitry to implement and/or instantiate the client devices 204 and/or the smart device 208 of FIG. 4, is shown in FIG. 6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 6, many other methods of implementing the example client devices 204 and/or the smart device 208 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed, instantiated, and/or performed by programmable circuitry to implement the client device 204A or the smart device 208. The machine-readable instructions and/or the operations 600 of FIG. 3 begin when the UDP transceiver circuitry 406 receives a beacon message from the local manager 202. (Block 602). The beacon message may be broadcasted by the local manager 202 to multiple devices requesting media in the local network using multicast techniques. The beacon message includes, among other data, the address of the local manager 202.

The beacon agent circuitry 410 extracts a local manager IP address from the beacon message and stores the address in memory 416. (Block 604). In other examples, the beacon agent circuitry 410 extracts a different type of address used to identify the local manager 202.

The request former circuitry 402 generates a request data structure directed to a content provider. (Block 606). The request data structure includes a request for a media stream provided by the identified content provider (e.g., content provider 102A). In some examples, the request data structure refers to a portion of the media stream as described above. The request former circuitry 402 generates the request data structure based on one or more control signals and the images presented on the playback device 206A.

The request modifier circuitry 412 modifies the request data structure with the local manager IP address. (Block 608). To modify the request data structure, the request modifier circuitry 412 removes any reference to the content provider 102A being the recipient of the request. The request modifier circuitry 412 also adds the local manager IP address to identify the local manager 202 as the recipient of the request.

The stream coordinator circuitry 414 transmits an HTTP request for media to the local manager 202. (Block 610). To transmit the request, the stream coordinator circuitry 414 first receives the modified request data structure and identifies the local manager 202 as the recipient.

In response to the transmission, the UDP transceiver circuitry 406 receives a UDP media stream from the local manager 202. (Block 612). The UDP media stream is composed of metadata and one or datagrams of video data that correspond to the requested media. In some examples, the UDP stream is multicasted to multiple client devices 204 by the local manager 202.

The media player circuitry 408 causes presentation of one or more portions of the media stream. (Block 614). In some examples, the stream coordinator circuitry 414 decapsulates the UDP stream to a HTTP stream and the media player circuitry 408 provides the video data as part of the HTTP stream. In other examples, the client device 204A provides the video data to the playback device 206A in a different format. In some examples, the media player circuitry 408 is implemented within the smart device 208 and communicates with an internal display module to cause the presentation of media.

In some examples, the request former circuitry 402 implements block 606 multiple times to generate multiple request data structures corresponding to respective portions of a media stream. In such examples, the client device 204A or smart device 208 may implement blocks 608-614 once for each execution of block 606. The machine readable instructions and/or operations 600 end after block 614.

FIG. 7 is a block diagram of an example programmable circuitry platform 700 structured to execute and/or instantiate the machine-readable instructions and/or the operations of FIG. 6 to implement any of the client device 204 of FIG. 2. The programmable circuitry platform 700 can be, for example, a set top box, a server, a personal computer, a workstation, an Internet appliance, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the request former circuitry 402, the media player circuitry 408, the beacon agent circuitry 410, the request modifier circuitry 412, and stream coordinator circuitry 414.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716. In this example, the main memory 714, 716 implements the example memory 416.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 720 implements the example HTTP transceiver circuitry 404 and the example UDP transceiver circuitry 406.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.). The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 6 to effectively instantiate the circuitry of FIG. 2 as logic circuits to perform operations corresponding to those machine readable instructions. In some such examples, the circuitry of FIG. 4 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCle bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814 (sometimes referred to as control circuitry), arithmetic and logic circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc.

The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

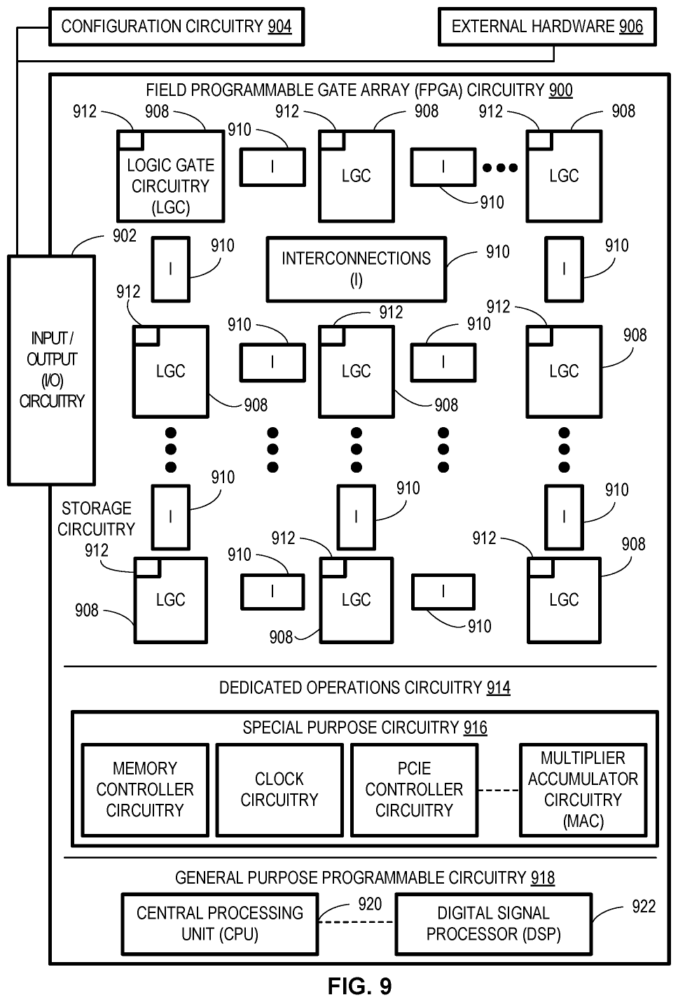

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 6. As such, the FPGA circuitry 900 may be configured and/or structured to effectively instantiate some or all of the operations/functions corresponding to the machine readable instructions of the flowchart(s) of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIG. 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 6, and/or an ASIC may be configured and/or structured to perform third operation(s)/function(s) corresponding to a third portion of the machine readable instructions represented by the flowcharts of FIG. 6.

It should be understood that some or all of the circuitry of FIG. 4 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 4 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

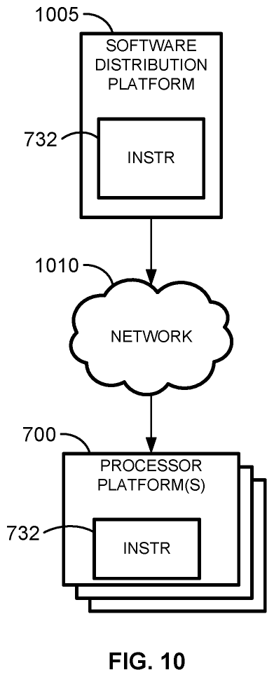

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIG. 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 6, may be downloaded to the example programmable circuitry platform 700, which is to execute the machine readable instructions 732 to implement the client device 204A. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed for a client device to avoid redirects by requesting media directly from a local manager. Disclosed systems, apparatus, articles of manufacture, and methods improve the efficiency of using a computing device by decreasing the time required for a client device 204A to discover and present media streams accessible by a local manager 202. Furthermore, the examples described in accordance with the teachings of this disclosure improve the quality of a user experience by mitigating latency of time sensitive media data. Examples described herein also decrease the total data traffic within a local network, enabling additional bandwidth to be used for other functions not related to media delivery. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to modify media requests are disclosed herein. Further examples and combinations thereof include the following.

Example 1 includes a system to modify requests for media, the system comprising programmable circuitry, a memory that stores executable instructions that, when executed or instantiated by the programmable circuitry, facilitate performance of operations, comprising forming a data structure representing a request to a content provider for a media stream, modifying the data structure to represent a request to a local manager for the media stream, the modified request data structure including an address corresponding to the local manager, transmitting a request to the local manager as a hypertext transfer protocol (HTTP) request, the request based on the modified data structure, and receiving a response from the local manager as a user datagram protocol (UDP) stream.

Example 2 includes the system of example 1, wherein the operations further comprise providing, based on the response, video data to a playback device.

Example 3 includes the system of example 2, wherein the video data includes a portion of the media stream generated by the content provider.

Example 4 includes the system of example 2, wherein the operations further comprise receiving the response as a UDP stream, decapsulating the UDP stream into a HTTP stream, and providing the video data to the playback device as part of the HTTP stream.

Example 5 includes the system of example 1, wherein the media stream is a first media stream, the content provider is a first content provider, the request data structure is a first request data structure, the operations further comprise forming a second request data structure for a second media stream, the second request data structure directed to a second content provider, and modifying the second request data structure using the address, the modified second request data structure directed to the local manager.

Example 6 includes the system of example 1, wherein the operations further comprise transmitting, using the address, an application programming interface (API) call to the local manager, and receiving, in response to the transmission of the API call, a description of the media stream accessible by the local manager.

Example 7 includes the system of example 1, wherein the programmable circuitry includes one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to machine-readable data, and one or more registers to store a result of the one or more first operations, the machine-readable data in the memory, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations.

Example 8 includes a non-transitory machine readable storage medium comprising instructions that, when executed or instantiated by programmable circuitry, facilitate performance of operations, comprising forming a data structure representing a request to a content provider for a media stream, and modifying the data structure to represent a request to a local manager for the media stream, the modified request data structure including an address corresponding to the local manager, transmitting a request to the local manager as a hypertext transfer protocol (HTTP) request, the request based on the modified data structure, and receiving a response from the local manager as a user datagram protocol (UDP) stream.

Example 9 includes the non-transitory machine readable storage medium of example 8, wherein the operations further comprise causing, based on the response, presentation of video data on a display.

Example 10 includes the non-transitory machine readable storage medium of example 9, wherein the video data includes a portion of the media stream generated by the content provider.

Example 11 includes the non-transitory machine readable storage medium of example 9, wherein the operations further comprise causing the presentation as a HTTP stream.

Example 12 includes the non-transitory machine readable storage medium of example 8, wherein the media stream is a first media stream, the content provider is a first content provider, the request data structure is a first request data structure, and the operations further comprise forming a second request data structure for a second media stream, the second request data structure directed to a second content provider, and modifying the second request data structure using the address, the modified second request directed to the local manager.

Example 13 includes the non-transitory machine readable storage medium of example 8, wherein the operations further include transmitting, using the address, an application programming interface (API) call to the local manager, and receiving, in response to the transmission of the API call, a description of the media stream accessible by the local manager.

Example 14 includes a method to redirect requests for media, the method comprising forming a data structure representing a request to a content provider for a media stream, modifying the data structure to represent a request to a local manager for the media stream, the modified request data structure including an address corresponding to the local manager, transmitting a request to the local manager as a hypertext transfer protocol (HTTP) request, the request based on the modified data structure, and receiving a response from the local manager as a user datagram protocol (UDP) stream.

Example 15 includes the method of example 14, further including providing, based on the response, video data to a playback device.

Example 16 includes the method of example 15, wherein the video data includes a portion of the media stream generated by the content provider.

Example 17 includes the method of example 15, further including receiving the response as a UDP stream, decapsulating the UDP stream into a HTTP stream, and providing the video data to the playback device as part of the HTTP stream.

Example 18 includes the method of example 14, wherein the media stream is a first media stream, the content provider is a first content provider, the request data structure is a first request data structure, and the method further includes forming a second request data structure for a second media stream, the second request data structure directed to a second content provider, and modifying the second request data structure using the address, the modified second request data structure directed to the local manager.

Example 19 includes the method of example 14, wherein the method further includes transmitting, using the address, an application programming interface (API) call to the local manager, and receiving, in response to the transmission of the API call, a description of the media stream accessible by the local manager.

Example 20 includes the method of example 14, wherein the extracting, the forming, or the modifying are implemented by one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to machine-readable data, and one or more registers to store a result of the one or more first operations, the machine-readable data in a memory, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations.

The following claims are hereby incorporated into this Detailed Description by this reference. Although certain systems, apparatus, articles of manufacture, and methods have been disclosed herein, these are presented as illustrative examples for purposes of providing a teaching disclosure, and the scope of coverage of this patent is not limited thereto. On the contrary, this patent covers all systems, apparatus, articles of manufacture, and methods fairly falling within the scope of the claims of this patent.

What is claimed is:

1. A system to modify requests for media, the system comprising:
programmable circuitry;
a memory that stores executable instructions that, when executed or instantiated by the programmable circuitry, facilitate performance of operations, comprising:
forming a data structure representing a request to a content provider for a media stream;
modifying the data structure to represent a request to a local manager for the media stream, the modified request data structure including an address corresponding to the local manager;
transmitting a request to the local manager as a hypertext transfer protocol (HTTP) request, the request based on the modified data structure; and
receiving a response from the local manager as a user datagram protocol (UDP) stream.

2. The system of claim 1, wherein the operations further comprise providing, based on the response, video data to a playback device.

3. The system of claim 2, wherein the video data includes a portion of the media stream generated by the content provider.

4. The system of claim 2, wherein the operations further comprise:
receiving the response as a UDP stream;
decapsulating the UDP stream into a HTTP stream; and
providing the video data to the playback device as part of the HTTP stream.

5. The system of claim 1, wherein:
the media stream is a first media stream;
the content provider is a first content provider;
the request data structure is a first request data structure;
the operations further comprise:
forming a second request data structure for a second media stream, the second request data structure directed to a second content provider; and
modifying the second request data structure using the address, the modified second request data structure directed to the local manager.

6. The system of claim 1, wherein the operations further comprise:
transmitting, using the address, an application programming interface (API) call to the local manager; and
receiving, in response to transmitting the API call, a description of the media stream accessible by the local manager.

7. The system of claim 1, wherein the programmable circuitry includes one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to machine-readable data, and one or more registers to store a result of the one or more first operations, the machine-readable data in the memory;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.

8. A non-transitory machine readable storage medium comprising instructions that, when executed or instantiated by programmable circuitry, facilitate performance of operations, comprising:
forming a data structure representing a request to a content provider for a media stream; and
modifying the data structure to represent a request to a local manager for the media stream, the modified request data structure including an address corresponding to the local manager;
transmitting a request to the local manager as a hypertext transfer protocol (HTTP) request, the request based on the modified data structure; and
receiving a response from the local manager as a user datagram protocol (UDP) stream.

9. The non-transitory machine readable storage medium of claim 8, wherein the operations further comprise causing, based on the response, presentation of video data on a display.

10. The non-transitory machine readable storage medium of claim 9, wherein the video data includes a portion of the media stream generated by the content provider.

11. The non-transitory machine readable storage medium of claim 9, wherein the operations further comprise causing the presentation as a HTTP stream.

12. The non-transitory machine readable storage medium of claim 8, wherein:
the media stream is a first media stream;
the content provider is a first content provider;
the request data structure is a first request data structure; and
the operations further comprise:
forming a second request data structure for a second media stream, the second request data structure directed to a second content provider; and
modifying the second request data structure using the address, the modified second request directed to the local manager.

13. The non-transitory machine readable storage medium of claim 8, wherein the operations further include:
transmitting, using the address, an application programming interface (API) call to the local manager; and
receiving, in response to transmitting the API call, a description of the media stream accessible by the local manager.

14. A method to redirect requests for media, the method comprising:
forming a data structure representing a request to a content provider for a media stream;
modifying the data structure to represent a request to a local manager for the media stream, the modified request data structure including an address corresponding to the local manager;
transmitting a request to the local manager as a hypertext transfer protocol (HTTP) request, the request based on the modified data structure; and
receiving a response from the local manager as a user datagram protocol (UDP) stream.

15. The method of claim 14, further including providing, based on the response, video data to a playback device.

16. The method of claim 15, wherein the video data includes a portion of the media stream generated by the content provider.

17. The method of claim 15, further including:
receiving the response as a UDP stream;
decapsulating the UDP stream into a HTTP stream; and
providing the video data to the playback device as part of the HTTP stream.

18. The method of claim 14, wherein:
the media stream is a first media stream;
the content provider is a first content provider;
the request data structure is a first request data structure; and
the method further includes:
forming a second request data structure for a second media stream, the second request data structure directed to a second content provider; and
modifying the second request data structure using the address, the modified second request data structure directed to the local manager.

19. The method of claim 14, wherein the method further includes:
transmitting, using the address, an application programming interface (API) call to the local manager; and
receiving, in response to transmitting the API call, a description of the media stream accessible by the local manager.

20. The method of claim 14, wherein the forming or the modifying are implemented by one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to machine-readable data, and one or more registers to store a result of the one or more first operations, the machine-readable data in a memory;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.
